(19) United States
(12) Patent Application Publication
(10) Pub. No.: US 2019/0238912 A1
(43) Pub. Date: Aug. 1, 2019

(54) METHOD AND SYSTEM FOR DISTRIBUTION OF TIMESENSTIVE VIDEO CONTENT

(71) Applicant: Jeffrey Jockisch, Port Saint Lucie, FL (US)

(72) Inventor: Jeffrey Jockisch, Port Saint Lucie, FL (US)

(21) Appl. No.: 16/252,500

(22) Filed: Jan. 18, 2019

Related U.S. Application Data
(60) Provisional application No. 62/623,105, filed on Jan. 29, 2018.

(51) Int. Cl. H04N 21/254; H04N 21/266; G06Q 20/12

(52) U.S. Cl. CPC H04N 21/2541; G06K 9/00288; G06Q 20/123; H04N 21/266

(57) ABSTRACT

A system and method are described for distribution of time sensitive video content. Video content providers upload content which is routed to a pool of content consumers based on metadata associated with content, content providers, and content consumers. Metadata may be used to assist a content provider in controlling value, licensing and distribution of content, and to deliver content to content consumers.

### BACKGROUND

### 1. Field of the Invention

The present invention is related to systems for analyzing and distributing video content and specifically to a method of optimizing distribution and maximizing value of newsworthy content.

### 2. Description of the Related Art

Currently the system for distribution and monetization of video content is rather broad, and is ad supported, such as YouTube. A user creates content and then tags it uploads it, and tries to attract viewers who then “pay” by viewing ads provided by the marketplace. This system works well enough for content which is not time sensitive, but is not well suited for electronic news gathering. As a result, most content on YouTube is produced rather than raw news footage. It's quite hard to locate raw news footage on social media.

Alternate systems have been implemented by services such as Stringr, and ScoopBroker. Such systems focus on a ‘pull’ model for content distribution, but may also allow a ‘push’ model. A user may accept “assignments” which describe a particular type of video content which an organization wishes to obtain, such as sports video, or other events of interest. Such a ‘pull’ system describes the time, location, license terms and an offer price. An obvious weakness of this type of system is that it does not monetize unpredictable events such as natural or man-made disasters well. Likewise such a system does not lend itself to obtaining content from individuals who collect content by coincidence, or in a non-professional context.

The ‘push’ system allows a user to apply tags to content, upload the content and then wait for bidders. This is somewhat similar to the YouTube approach since the buyers must actively seek content and must search based on tags or keywords. Such a system works well for the buyers, but may place the seller at a disadvantage as there is no predictable market value for content which may have a finite shelf life. Likewise the ‘push’ system is not adapted well to generating requests for content which has not been produced and/or scripted but is simply obtained in its unedited form.

Due to these and other problems a method and system for distribution of time sensitive video content would be greatly appreciated.

### SUMMARY

A server is provided which can aggregate uploaded content and make it available to potential buyers of the content. Content may be uploaded using front-end technologies such a web browser or web app, or via a dedicated app resident on a user device such as a mobile phone or tablet. Content providers may connect to the server using any device associated with a content provider. Content consumers may be various types of organizations or individuals. News publishers, public safety groups and government agencies may all act as content consumers. Content consumers may be able to preview content using any device associated with a content consumer. Content consumers may identify types of content which is of interest based on tags, as well as geographic, and/or subject material categories.

A content provider device may receive various notifications regarding content. A content provider device may associate metadata regarding content with content. Metadata may be assigned based on selections made using a content provider device. Licensing data may be associated with content based on selections made using a content provider device. Metadata may be associated with content based on analysis of the content. For example, an Artificial Intelligence (Al) system may be used to identify subject matter, persons and/or places, objects, etc., which are determined to be associated with content.

Content may be distributed based on various criteria. A content consumer may elect to receive content on an unlicensed basis based on metadata associated with the content. For example, a public safety agency or animal control organization might elect to receive content which is associated with metadata such as location, subject matter and whether content is tagged by a content provider, and/or a particular Al resource. Metadata could both be selected by a content consumer and/or suggested to a content consumer based on historical consumption, organizational profile information and other criteria. Content may be distributed to multiple content consumers based on factors such as age of content.

A content provider may associate various types of metadata with content which may affect distribution and availability of content. For example, a content provider may elect to provide content anonymously, pseudonymously or with personally identifying information. A content provider device may receive information regarding potential distribution channels for content. A content provider device may receive information regarding licensing options for content. A content provider device may receive information regarding historical value of content based on metadata associated with content.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for a content item.

FIG. 3 illustrates a database for a content provider.

FIG. 4 illustrates a database for a content consumer.

FIG. 5 is a flowchart of obtaining content.

FIG. 6 is a flowchart of distributing content.

FIG. 7 is a flowchart of registering a content provider.

FIG. 8 is a flowchart of registering a content consumer.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A content distribution system is provided which enables a content provider to easily obtain and distribute video content to a variety of content consumers. Content can be more effectively targeted and opportunity for exposure can be optimized through a variety of channels of content consumers. Content consumer networks and channels can be organized according to various paradigms. For example, national, regional, or local content consumers may be identified and content obtained by a content provider may be distributed to a channel within a network based on interests of content consumers as well as consumption patterns associated with a content consumer.

A content distribution channel may be selected based on temporal factors associated with content. For example, content which is past a pre-determined age, which may be based on metadata associated with the content may be routed to secondary or tertiary distribution channels which may include content consumers which are directed toward different purposes for usage. For example, if content is determined to be of local interest and is current, it might be distributed to local television stations, and simultaneously to law enforcement and/or other governmental agencies which are relevant consumers. Subsequently distributors which act as aggregators of topic matter content might become a target distribution channel for ageing content. In other instances a channel which distributes stock videos for use in republishing or derivatives might be targeted.

A content producer is provided with a toolset which allows a novice to secure, market and distribute time sensitive and newsworthy video content without any particular legal, marketing, production, security or technology skills. A web app or device app, such as an iOS® or Android® app may be provided which may permit any person who can operate a recording device to transfer information of content to a secure but publicly accessible storage facility. A content provider may be provided with editing and/or post production tools. A content provider may be able to use natural language tagging of content to determine metadata regarding content and to select licensing terms, and distribution conditions associated with content consumers which may be used to route information of available content to content consumers. A facility may be provided which may assist a content provider in understanding the potential value of content and to obtain and protect the rights of the content provider to control distribution of content.

A distribution system may comprise various components which may provide analysis of content. For example, an image analysis system, which might incorporate object recognition, facial recognition, and/or other forms of visual and audio analysis. Content analysis tools may be used to determine proper distribution parameters and metadata to be associated with content to effect distribution of content. For example, an API such as the Tensor Flow API might be used to recognize classes of objects and/or faces within a video clip and to associate metadata with content in order to facilitate routing and distribution of content to content consumers.

A content provider may receive information of types of content which are in demand. For example, a content distribution system may obtain information from news sources such as police and emergency responder radio, weather services, traffic monitoring services, etc., which may be used identify types of time sensitive, newsworthy content which may have been obtained by casual observation and/or geographic coincidence. For example, if there is a natural disaster such as a flood, storm, or earthquake, video content by any or all local residents might be solicited and distributed to assist in disaster relief and assessment as well as providing a greater assortment of content for agencies and/or news consumption. Content providers who might otherwise merely post to personal social media might instead provide such content to a content distribution network.

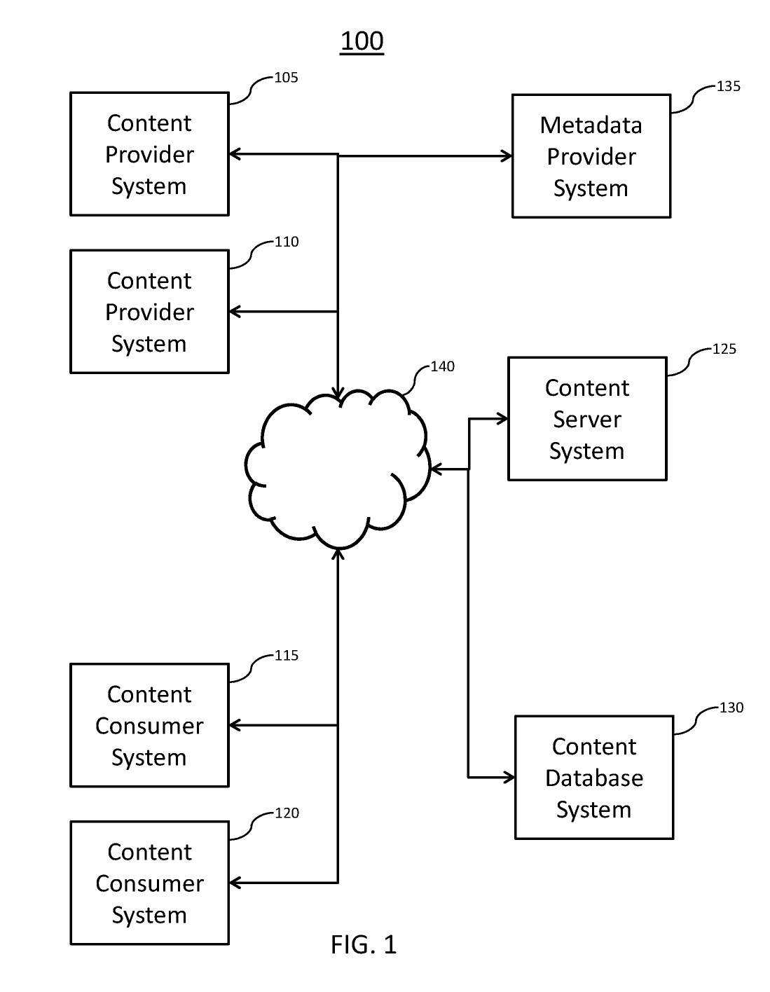

As illustrated in FIG. 1, system 100 includes content provider systems 105, 110, content consumer systems 115, 120, a content server system 125, a content system database, 130, metadata provider system 135, and a network 140.

A content provider system such as the content provider system 105, may submit a request to the content server system 125 and/or may receive a response from the content server system 125. A content provider system may obtain content in any suitable manner, for example a built in acquisition device such as a camera of the content provider system 105 may record content which is made available to the content server system 125. A content provider system may obtain actions of a person operating a content provider system which may be used to associate metadata with content. For example, the content provider system 105, might provide metadata associated with a person operating the content provider system. Similarly, built in location tracking features of the content provider system 105, might associate metadata indicating a geographic location with content provided by the provider system 105. A content provider system might perform analysis of a video clip and/or audio in order to associate metadata with content. A content provider system may obtain suggested metadata from the content server system 125. A content provider system may receive suggestions regarding licensing and pricing which may be associated with content. A user interface such as a web page, or Graphical User Interface (GUI) may be provided via a content provider system.

A content provider system may enable a content provider to register with the content server system 125. A content provider system may allow a content provider to choose various levels of personally identifying information which may be associated with content. For example, content might require specific personal attribution of a person providing the content in order that the content can be distributed to a content consumer. Similarly, a content provider system may allow a content provider to submit content in an anonymous manner. For example, a content provider might have concerns regarding consequences of publication of content which would be directed to the content provider if the content provider was publicly identified as a source of the content. A content provider system may allow a content provider to direct how compensation for distribution of content is to be provided. For example, banking information or other types of transactional account information may be obtained by the content server system 125, which may be provided by a content provider system. A content provider system may provide information regarding production parameters of content such as frame rate, resolution, encoding, bit-rate, etc. which may be used to route and distribute content to content consumer systems.

A content consumer system such as the content consumer system 115 may receive and/or send a message to the content server system 125. For example, a content consumer system may receive a notification that a particular type of content is available. For example, if a content consumer is a public safety agency, it might receive a notification that content relating to a fire at a particular location within geographic boundary established by the content provider is available. In such an instance the content might be provided to first responders, who might be in transit to the location and would benefit from situational analysis. A content consumer system may request content associated with various types of metadata. For example, the content consumer system 120 might request video content associated with stray animals in a geographic area associated with rainy or cold weather.

A content consumer system may provide information associated with a person or entity. For example, a content provider system might provide geographic and business contact information associated with a provider of news services, or a public or private safety service. A content consumer system may receive recommendations of metadata which may be used to obtain content based on preferences provided by a content consumer, historical consumption of content, pricing, bidding, time, etc. A content consumer system may provide a GUI and/or web or Application Programming Interface (API) to allow access to the system 100.

The network 140 may be a global public network of networks (i.e., the Internet) and/or may consist in whole or in part of one or more private networks and communicatively couples the content provider systems 105, 110, content consumer systems 115, 120, the content server system 125, the content database system 130, and the metadata provider systems 135 with each other. The network 140 may include one or more wireless networks which may enable wireless communication between the various elements of the system 100.

The content provider systems 105, 110, content consumer systems 115, 120 the content server system 125, the content database system 130, and the metadata provider systems 135 and the network 140 may include equipment, software, systems and personnel required to send and/or receive messages between the content provider systems 105, 110, content consumer systems 115, 120 the content server system 125, the content database system 130, and the metadata provider systems 135.

A content provider system, a content consumer system, a content server system, a metadata provider system, and/or a content server database may be a desktop, portable, or tablet PC or Mac®, a mobile phone, a smart phone, a PDA, a server system, a specialized communication terminal, a terminal connected to a mainframe, or any suitable communication hardware and/or system. For example, servers such as the PowerEdge® 2900 by Dell, or the BladeCenterJS22 by IBM, or equivalent systems which might use an operating system such as Linux, Windows® XP, etc. might be used as the content server system. After being presented with the disclosure herein, one of ordinary skill in the relevant art will immediately realize that any viable computer systems or communication devices known in the art may be used as content server systems, content provider systems, content consumer systems, content database systems and metadata provider systems. While only a few content provider systems, content consumer systems, metadata provider systems, content server systems and content database systems are depicted in FIG. 1, it is envisioned that few content provider systems, content consumer systems, metadata provider systems, content server systems and content database systems. The content server 125 may include storage devices which may record information in a database which may be a separate device from the content server 125. Records maintained in a content database server may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, MongoDb® etc., and may also be a distributed database on more than one server. Any suitable hardware and software components which are able to implement the required functionalities which are well known in the art may be used to implement the content database server.

In an embodiment, a content provider system and/or a content consumer system may request and/or receive an application or “app” from a server such as the iPhone AppStore or Google Play Store, which may be operative on a content provide system and/or a content consumer system.

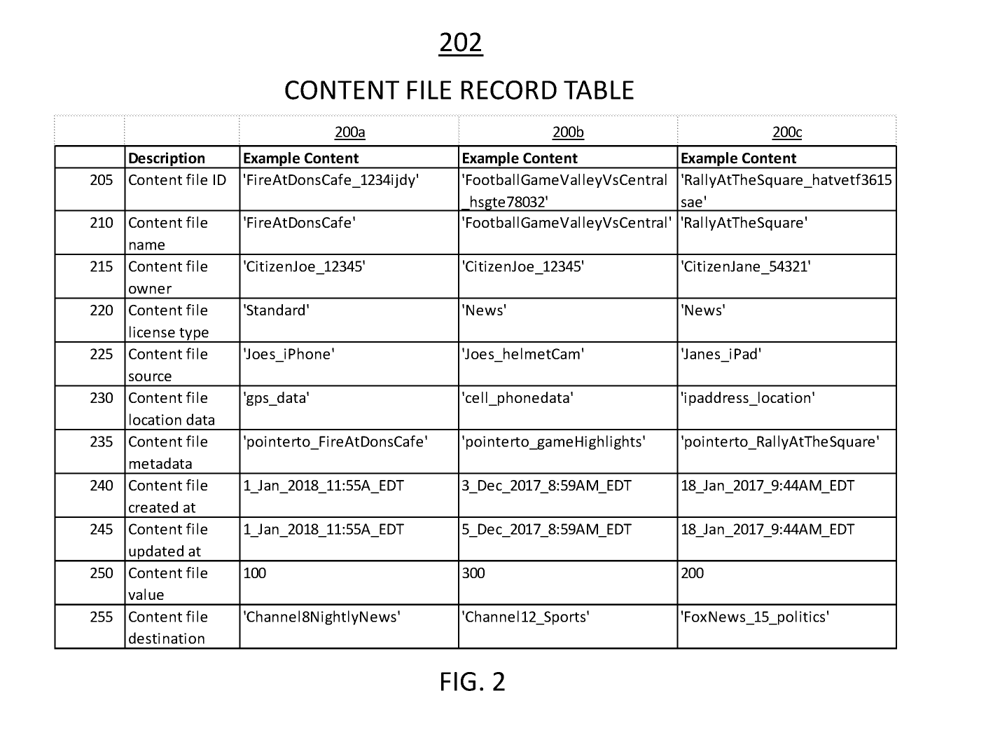

As illustrated in FIG. 2 a content file record table 202 which may comprise a number of content file records 200 of which one or more may be associated with the content database system 130 (FIG. 1) is provided. The content file record table 202 may include information of content files. The content file records 200a-c may include a content file ID field 205, a content file name field 210, a content file owner field 215, a content file license type field 220, a content file source field 225, a content file location data field 230, a content file metadata field 235, a content file created at field 240, a content file updated at field 245, a content file value field 250 and a content file destination field 255.

The content file ID field 205 may include information of a content file ID. A content file ID is preferably unique and used consistently. A content file ID may be used to identify a particular content file, and serves to distinguish a content file record associated with a content file from content file device records associated with other content files. For example, ‘FireAtDonsCafe_1234ijdy’ is the content file ID associated with the content file record 200a. A content file ID may be associated with a content file by the content server system 125 (FIG. 1).

The content file name field 210 may include information of a name assigned to a content file. A content file name may for example be assigned by a person controlling a content provider system. The content file owner field 215 may include information of a person or entity which has rights associated with a content file. For example a content provider ID may be associated with a content provider and might be indicated in the content file owner field 215. As illustrated in FIG. 2, ‘CitizenJoe_12345’ is the content file owner associated with the content file record 200a. The content file license type field 220 may include information of a licensing type associated with a content file. Content of the content provider license type field 220 may be used to determine distribution of information regarding a content file to a content consumer system. For example if a content consumer is willing to accept the terms of a particular license agreement, a content consumer may receive a notification that a content file associated with the license agreement is available. The content file source field 225 may include information of a source associated with a content file. For example an indicator of a device which has acquired a content file may be indicated in the content file source field 225. Content of the content file source field may be used to determine distribution of content. For example, capabilities of a device indicated content file source field 225 may be used to include or exclude content consumers from a target group to receive information of a content file.

The content file location data field 230 may include information regarding a geographic location associated with a content file. For example, Global Positioning System (GPS) data, cell tower triangulation data, IP address information, postal code, latitude, longitude, altitude, and/or other types of information which may indicate geographic location may be indicated in the content file location data field 230. Location data may be used to determine distribution of information of a content file. The content file metadata field 235 may include metadata (data about data) regarding a content file. Any type of metadata associated with a content file may be indicated in the content file metadata field 235. For example, keywords and/or tags, named entities, etc., may be indicated in the content file metadata field 235. Content indicated in the content file metadata field 235 may be determined according to various means. For example, a content provider may associate a natural language description with a content file, which may be processed in order to associate metadata which has been prepared in the content database system 130 (FIG. 1) with a content file. Information indicated in the content file metadata field 235 may be used to determine value, distribution, and licensing associated with a content file.

The content file created at field 240 may indicate temporal data regarding when a content file is created. For example, Universal Time Code (UTC) data might be indicated in the content file created at field 240. The content file updated at field 245 may indicate temporal data regarding a modification of a content file. For example, if a change occurs to metadata, geographic data, license data, file owner data, or any change to a content file record, an indication of the time at which the file is modified may be indicated in the content file updated at field 245. Temporal information such as the content file created at field 240 and the content file updated at field 245 may be used to determine distribution, licensing, value, and/or other parameters associated with a content file.

The content file value field 250 may indicate a value associated with a content file. For example an accrued amount of compensation associated with a content file may be indicated in the content file value field 250. An estimated value of a content file may be indicated in the content file value field 250. The content file destination field 255 may include information of a destination associated with a content file. For example, an indicator of a content consumer may be indicated in the content file destination field 255. Any number of content consumers might be indicated in the content file destination field 255. Information of a content file may be delivered to a destination indicated in the content file destination field 255 in an order based on a rating and/or ranking of content consumers indicated in the content file destination field 255.

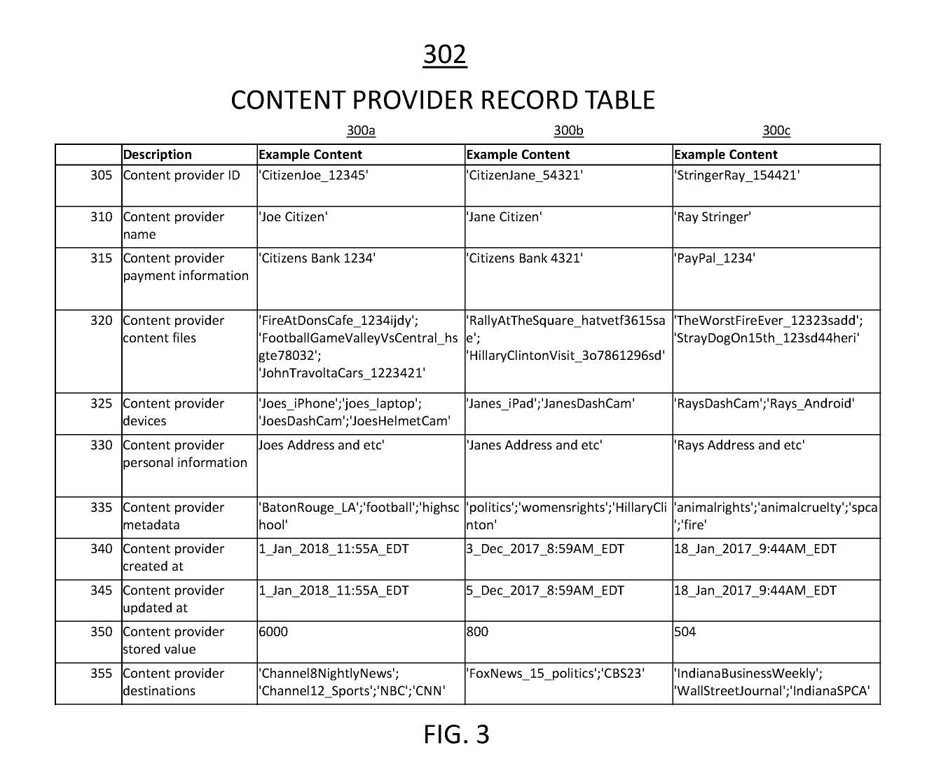

As illustrated in FIG. 3 a content provider record table 302 which may comprise a number of content provider records 300 of which one or more may be associated with the content database system 130 (FIG. 1) is provided. The content provider record table 302 may include information of content providers. The content provider records 300a-c may include a content provider ID field 305, a content provider name field 310, a content provider payment information field 315, a content provider content files field 320, a content provider devices field 325, a content provider personal information field 330, a content provider metadata field 335, a content provider created at field 340, a content provider updated at field 345, a content provider stored value field 350 and a content provider destinations field 355.

The content provider ID field 305 may include information of a content provider ID. A content provider ID is preferably unique and used consistently. A content provider ID may be used to identify a particular content provider, and serves to distinguish a content provider record associated with a content provider from content provider device records associated with other content providers. For example, ‘CitizenJoe_12345’ is the content provider ID associated with the content provider record 300a. A content provider ID may be associated with a content provider by the content server system 125 (FIG. 1).

The content provider name field 310 may include information of a name assigned to a content provider. A content provider name may for example be assigned by a person controlling a content provider system. The content provider payment information field 315 may include information of how compensation is delivered to a content provider. For example banking information, a PayPal® account credential, and/or any other method of delivering compensation may be indicated in the content provider payment information field 315. As illustrated in FIG. 3, ‘Citizens Bank 1234’ is the content provider payment information associated with the content provider record 300a. The content provider content files field 320 may include information of a content file associated with a content provider. For example, and indicator of a content file such as a content file ID associated with a content file record indicated in the content file record table 202 (FIG. 2) might be indicated in the content provider content files field 320. The content provider devices field 325 may include information of a device associated with a content provider. For example an indicator of a device which has acquired a content file which is provided by a content provider system may be indicated in the content provider devices field 325. Content of the content provider devices field may be used to determine ownership of a content file. For example, a unique identifier of a device such as an International Mobile Equipment Identifier (IMEI) number may be associated with a content provider and may be indicated in the content provider devices field 325. An identifier associated with a content provider device may be assigned based on an action associated with a person operating a content provider system.

The content provider personal information field 330 may include information regarding Personally Identifying Information (PII) of a content provider. For example, name, address, passport number, government issued identity numbers, mobile phone numbers, and or any other data which may be uniquely associated with identity of a content provider may be indicated in the content provider personal information field 330. PII of a content provider may be used to verify the identity of a content provider. PII may be provided in addition to information of a content file to a content consumer with proper permissions. The content provider metadata field 335 may include metadata regarding a content provider. Any type of metadata associated with a content provider may be indicated in the content provider metadata field 335. For example, keywords and/or tags, named entities, etc., may be indicated in the content provider metadata field 335. Content indicated in the content provider metadata field 335 may be determined according to various means. For example, a content provider may associate a natural language description with a content provider, which may be processed in order to associate metadata which has been prepared in the content database system 130 (FIG. 1) with a content provider. Information indicated in the content provider metadata field 335 may be used to determine value, distribution, and licensing associated with a content provider. Any type of information which a content provider may elect to make available may be processed in order to associate metadata with a content provider. For example, social media accounts, email accounts, and/or other types of login information may be analyzed to determine metadata associated with a content provider.

The content provider created at field 340 may indicate temporal data regarding when a content provider is created. For example, Universal Time Code (UTC) data might be indicated in the content provider created at field 340. The content provider updated at field 345 may indicate temporal data regarding a modification of a content provider. For example, if a change occurs to metadata, geographic data, personal information, content file data, or any change to a content provider record, an indication of the time at which the record is modified may be indicated in the content provider updated at field 345. Temporal information such as the content provider created at field 340 and the content provider updated at field 345 may be used to determine distribution, licensing, value, and/or other parameters associated with a content provider.

The content provider stored value field 350 may indicate a value associated with a content provider. For example an accrued amount of compensation associated with a content provider may be indicated in the content provider value field 350. An estimated value of a content file may be indicated in the content provider value field 350. The content provider destinations field 355 may include information of a destination associated with a content provider. For example, an indicator of a content consumer may be indicated in the content provider destinations field 355. Likewise, if a content consumer has elected to receive and/or provide compensation for a content file, an indicator of a content consumer may be indicated in the content provider destinations field 355. Any number of content consumers might be indicated in the content provider destination field 355. Information of a content provider may be delivered to a destination indicated in the content provider destination field 355 in an order based on a rating and/or ranking of content consumers indicated in the content provider destination field 355.

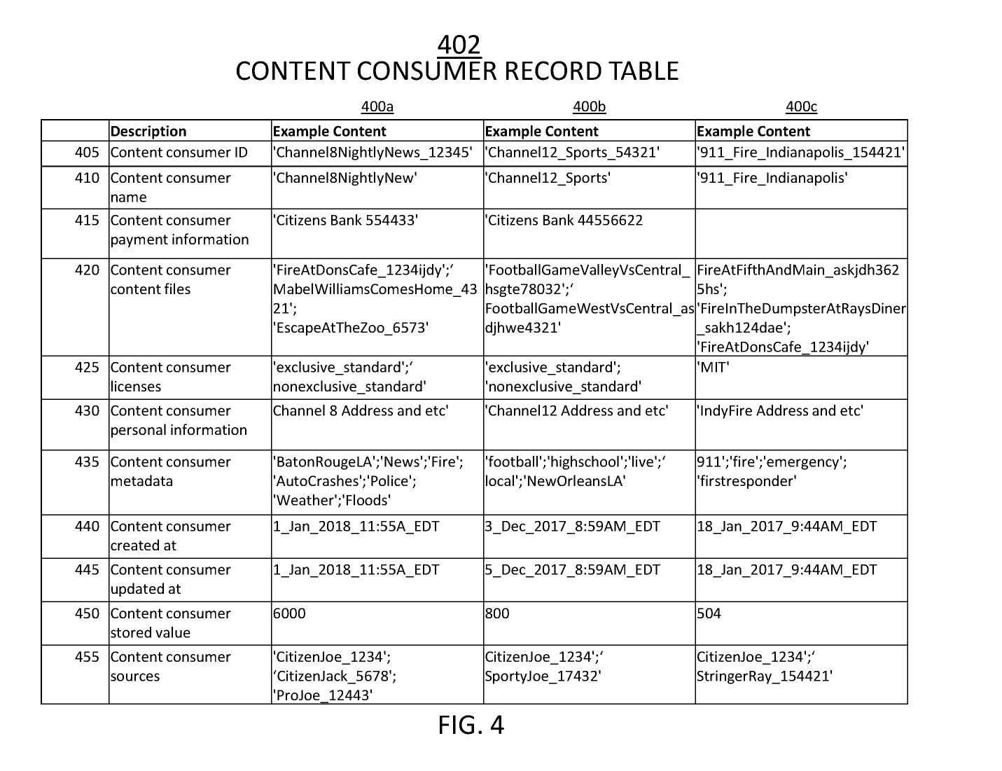

As illustrated in FIG. 4 a content consumer record table 402 which may comprise a number of content consumer records 400 of which one or more may be associated with the content database system 130 (FIG. 1) is provided. The content consumer record table 402 may include information of content consumers. The content consumer records 400a-c may include a content consumer ID field 405, a content consumer name field 410, a content consumer payment information field 415, a content consumer content files field 420, a content consumer licenses field 425, a content consumer personal information field 430, a content consumer metadata field 435, a content consumer created at field 440, a content consumer updated at field 445, a content consumer stored value field 450 and a content consumer sources field 455.

The content consumer ID field 405 may include information of a content consumer ID. A content consumer ID is preferably unique and used consistently. A content consumer ID may be used to identify a particular content consumer, and serves to distinguish a content consumer record associated with a content consumer from content consumer device records associated with other content consumers. For example, ‘Channel8NightlyNews_12345’ is the content consumer ID associated with the content consumer record 400a. A content consumer ID may be associated with a content consumer by the content server system 125 (FIG. 1).

The content consumer name field 410 may include information of a name assigned to a content consumer. A content consumer name may for example be assigned by a person controlling a content consumer system. The content consumer payment information field 415 may include information of how compensation is obtained from a content provider. For example banking information, a PayPal® account credential, and/or any other method of delivering compensation may be indicated in the content consumer payment information field 415. As illustrated in FIG. 4, ‘Citizens Bank 1234’ is the content consumer payment information associated with the content consumer record 400a. The content consumer content files field 420 may include information of a content file associated with a content consumer. For example, and indicator of a content file such as a content file ID associated with a content file record indicated in the content file record table 202 (FIG. 2) might be indicated in the content consumer content files field 420. The content consumer licenses field 425 may include information of a license associated with a content consumer. For example, a number of standardized agreements for licensing content may be provided to content consumers and/or content providers by the content distribution server 125 (FIG. 1). An indicator of a set of terms may be indicated in the content consumer licenses field 425 based on an action of a person operating a content consumer system. Information of a content file may be delivered to a content consumer system based on content of the content consumer licenses field 425.

The content consumer personal information field 430 may include information regarding Personally Identifying Information (PII) of a content consumer. For example, name, address, passport number, government issued identity numbers, mobile phone numbers, Tax Payer Id Number (TIN) and/or any other data which may be uniquely associated with identity of a content consumer may be indicated in the content consumer personal information field 430. PII of a content consumer may be used to verify the identity of a content consumer. PII may be provided in addition to information of a value offered for a content file may be provided to a content provider system with proper permission. The content consumer metadata field 435 may include metadata regarding a content consumer. Any type of metadata associated with a content consumer may be indicated in the content consumer metadata field 435. For example, keywords and/or tags, named entities, etc., may be indicated in the content consumer metadata field 435. Content indicated in the content consumer metadata field 435 may be determined according to various means. For example, a content consumer may associate a natural language description with a content consumer, which may be processed in order to associate metadata which has been prepared in the content database system 130 (FIG. 1) with a content consumer. Information indicated in the content consumer metadata field 435 may be used to determine value, distribution, and licensing associated with a content consumer. Any type of information which a content consumer may elect to make available may be processed in order to associate metadata with a content consumer. For example, social media accounts, email accounts, and/or other types of login information may be analyzed to determine metadata associated with a content consumer.

The content consumer created at field 440 may indicate temporal data regarding when a content consumer is created. For example, Universal Time Code (UTC) data might be indicated in the content consumer created at field 440. The content consumer updated at field 445 may indicate temporal data regarding a modification of a content consumer. For example, if a change occurs to metadata, geographic data, personal information, content file data, or any change to a content consumer record, an indication of the time at which the record is modified may be indicated in the content consumer updated at field 445. Temporal information such as the content consumer created at field 440 and the content consumer updated at field 445 may be used to determine distribution, licensing, value, and/or other parameters associated with a content consumer.

The content consumer stored value field 450 may indicate a value associated with a content consumer. For example an available amount of compensation associated with a content consumer may be indicated in the content consumer value field 450. An estimated value of a content file may be deducted from a value indicated in the content consumer value field 450 based on a conditional offer for a content file. Transactions such as receipt of a content file by a content consumer system, an offer or bid received from an operator of a content consumer system, a payment of compensation to a provider of the content distribution system 125 (FIG. 1), etc., may affect content of the content consumer stored value field 450. The content consumer sources field 455 may include information of a source associated with a content consumer. For example, an indicator of a content provider may be indicated in the content consumer destinations field 455. Likewise, if a content consumer has elected to receive and/or provide compensation for a content file, an indicator of a content provider may be indicated in the content consumer sources field 455. Any number of content providers might be indicated in the content consumer sources field 455. Information of a content consumer may be delivered to a destination indicated in the content consumer sources field 455 in an order based on a rating and/or ranking of content consumers indicated in the content consumer sources field 455. For example, a content consumer which offered a higher level of compensation for a content file might be ranked higher and thus be more likely to be presented to a content provider system responsive to content which ranked highly for metadata associated with a content file and a content consumer than a content consumer which offered a lower level of compensation.

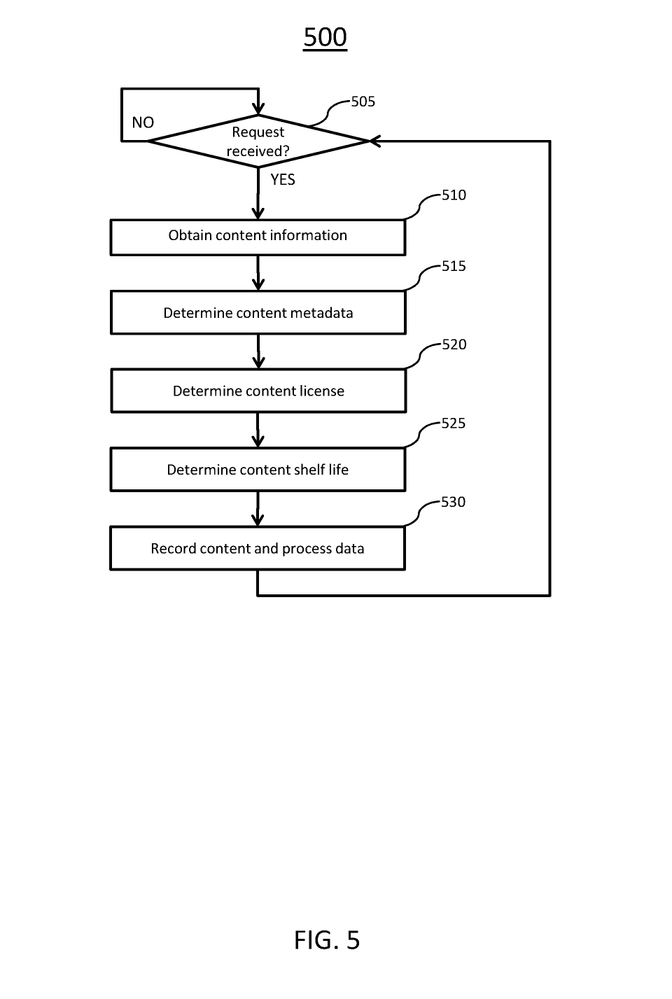

As illustrated in FIG. 5 a process 500 for obtaining a content file is provided. The process 500 may be performed in whole or in part by any suitable element of the system 100(FIG. 1). In at least one embodiment, the process 500 is operative on the content distribution server 125. A request to provide content may originate from any device available in the system 100. A request to provide content may be received responsive to a description of an event received by a content provider system. A request to provide content may be originated by a content provider system.

In operation 505 (FIG. 5) a determination is made as to whether a request to provide content is received. If it is determined in operation 505 that a request to provide content is not received, control remains at operation 505 and process 500 continues. If it is determined in operation 505 that a request to provide content is received, control is passed to operation 510 and process 500 continues.

The determination in operation 505 may be made using various criteria. In at least one embodiment, if a request to provide content is received at a server associated with the content server system 125 (FIG. 1), it may be determined that a request to provide content is received. For example, if a request at an address associated with content server system 125 it may be determined that a request to provide content is received. An authorization and/or verification process including security data may be required as part of a determination that a request to provide content is received.

In operation 510 content information is obtained. For example a file may be received which comprises an Mpeg4 (.mp4) file might be received. Likewise a Universal Resource Locator (URL) associated with a file location might be received. Any suitable means for providing information of content may be used to provide content information. For example, a web form which might include files, or a message constructed by an app resident on a content provider system might be used to provide content information. Control is passed to operation 515 and process 500 continues.

In operation 515 content metadata is determined. Content metadata may be determined in various ways. For example, metadata may be assigned based on an action of a person operating a content provider system. For example, a person operating a content provider system might enter a natural language description of content provided, which might be analyzed to determine metadata associated with a content file. Similarly metadata such as geographic location, content format, etc., might be obtained programmatically from a content provider system. Information of a content file might be provided to an automated and/or human assisted resource such as the metadata provider system 135 which might provide metadata to the content server systems and/or a content provider system. For example analysis of audio, images, and/or other content indicated in a content file might be processed to determine metadata of objects, words, and/or persons indicated in a content file. Control is passed to operation 520 and process 500 continues.

In operation 520 a content license is determined. Any number of content licenses may be determined. For example, a content license for emergency responders, a content license for news organizations, and a content license for redistribution might be determined. A content license may be determined based on an action of a person operating a content provider system. A content provider system might be provided with information of various content license options and an expected value associated with content license options. Control is passed to operation 525 and process 500 continues.

In operation 525 content shelf life is determined. Content shelf life may relate to various factors. For example, if content is related to breaking news, its shelf life might be determined to be short for content consumers in the news distribution channel. Alternately content shelf life for republication content consumers might be longer than for news distribution channels. Likewise, for first responders or government agencies content shelf life might be short due to the time sensitive nature of the content while investigative content consumers might have a longer shelf life. Shelf life may be determined at least in part based on metadata associated with a content file. Control is passed to operation 530 and process 500 continues.

In operation 530 content and process information is recorded. For example, if a content provider device has not previously been associated with a content provider a content provider record might be modified to indicate the content provider device. Similarly if metadata has not previously been associated with a content provider, metadata associated with a content file might be indicated in a content provide record. A request to provide content may comprise a request to modify and/or analyze content which has been previously provided. For example, if a content provider has additional information of video content associated with a previous content file, a request to provide content may include editing and/or modification of previously provided content. Control is passed to operation 505 and process 500 continues.

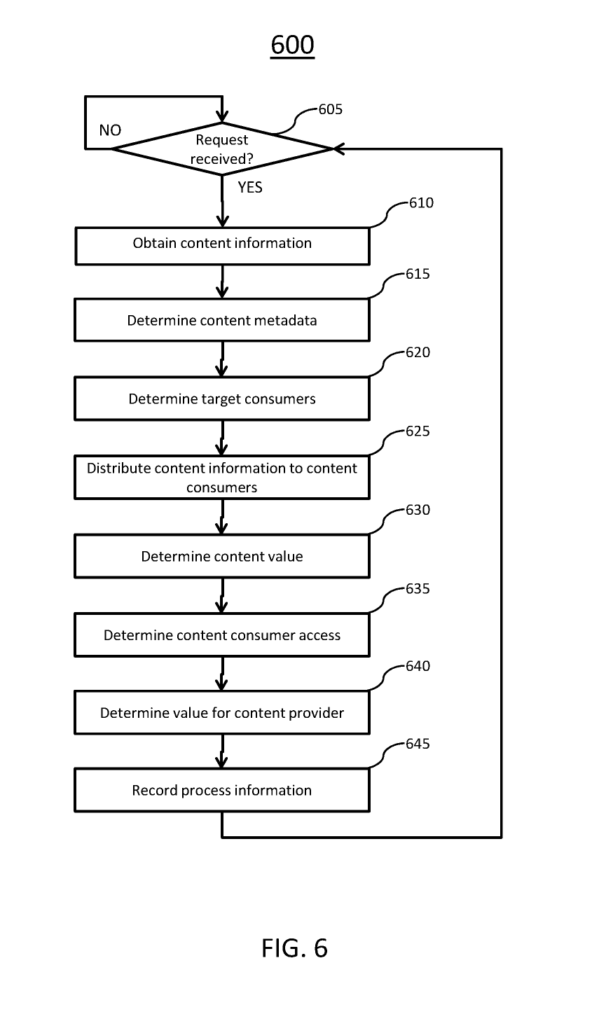

As illustrated in FIG. 6 a process 600 for distributing content is provided. The process 600 may be performed in whole or in part by any suitable element of the system 100(FIG. 1). In at least one embodiment, the process 600 is operative on the content distribution server 125. A request to distribute content may originate from any device available in the system 100. A request to distribute content may be received responsive to submission of content via a process such as the process 500 (FIG. 5) operative on a content provider system. A request to distribute content may be originated by a content consumer system.

In operation 605 (FIG. 6) a determination is made as to whether a request to distribute content is received. If it is determined in operation 605 that a request to distribute content is not received, control remains at operation 605 and process 600 continues. If it is determined in operation 605 that a request to distribute content is received, control is passed to operation 610 and process 600 continues.

The determination in operation 605 may be made using various criteria. In at least one embodiment, if a request to distribute content is received at a server associated with the content server system 125 (FIG. 1), it may be determined that a request to distribute content is received. For example, if a request is received from a content provider system at an address associated with content server system 125 it may be determined that a request to distribute content is received. Similarly if a request from a content consumer system is received at a system associated with the content server system 125, it may be determined that a request to distribute content has been received. An authorization and/or verification process including security data may be required as part of a determination that a request to distribute content is received.

In operation 610 content information is obtained. For example a file may be received which comprises an Mpeg4 (.mp4) file might be received. Likewise a Universal Resource Locator (URL) associated with a file location might be received. Any suitable means for obtaining information of content may be used to obtain content information. For example, a web form which might include files, or a message constructed by an app resident on a content provider system might be used to obtain content information. In an embodiment, database records, such as the content file record table 202 (FIG. 2) may be processed to obtain content information. Control is passed to operation 615 and process 600 continues.

In operation 615 content metadata is determined. Content metadata may be determined in various ways as described herein. In an embodiment, database records, such as the content file record table 202 (FIG. 2) may be processed to obtain content metadata. Control is passed to operation 620 and process 600 continues.

In operation 620 target consumers are determined. Any number of target content consumers may be determined. For example, if content metadata indicates that content is relevant to a public safety agency or a governmental institution, the public safety agency or the governmental institution may be determined to be a target consumer. A ranking of content consumers based on content metadata may be performed to determine target consumers. For example, geographic location data associated with a content file may be compared with geographic location data associated with a content consumer in order to determine a ranking of content consumers which may determine that a content consumer is a target consumer. Similarly, if content is to be distributed to publishers such as news organizations, metadata associated with publishers may be compared to metadata associated with a content file to establish whether a publisher is a target consumer. If content is to be delivered to redistributors metadata associated with redistributors may be compared to metadata associated with a content file to determine a target consumer. For example, a redistributor which has provided higher levels of compensation for content files associated with a keyword, category, subject matter, location, etc., a redistributor may be more likely to be selected as a target consumer. Any suitable criteria may be used to rank content consumers in order to determine a target consumer. Control is passed to operation 625 and process 600 continues.

In operation 625 content information is distributed to content consumers. Content information may be delivered in various ways. For example, a communication channel may be used to deliver any portion of a content file to a target content consumer. For example, a ‘push’ notification may be sent to a content consumer system to inform a person operating the content consumer system that content is available for review, purchase, bidding, etc. Content information may include identifiers of other content consumers to which a content file is being offered. Content information may include information of licensing and usage terms associated with a content file. Control is passed to operation 630 and process 600 continues.

In operation 630 content value is determined. Content value may be determined in various ways. For example, offers received from content consumers responsive to content information provided to content consumers may be analyzed to determine content value. Historical information of content which is associated with metadata associated with a content file may be used to determine content value. For example prices paid by content consumers for content files associated with metadata associated with a content file may be used to estimate content value. Control is passed to operation 635 and process 600 continues.

In operation 635 content consumer access is determined. Content consumer access may be determined based on various factors. For example, if licensing terms are non-exclusive any number of content consumers may be determined to be allowed to access to a content file. Content consumer access may be determined based on a minimum value offered by a content consumer. For example, a ‘Dutch Auction’ rule might be applied to determine content consumer access. Content consumer access may be determined based on geographic data of distribution. For example, access may be determined based on exclusivity for a pre-determined geographic territory. Any suitable criteria may be used to determine content consumer access to a content file. Control is passed to operation 640 and process 600 continues.

In operation 640 value for a content provider is determined. Value for a content provider may be determined based on information provided by a content consumer. For example, if a content consumer agrees to pay an amount for rights associated with a content file associated with a content provider value for a content provider may be determined based on the amount. If a content file is delivered to a public safety agency or government entity, a pre-determined value may be accrued to a content provider. Value for a content provider may be an intangible asset such as a rating and/or reputation certification. For example if a content provider is found to be a reliable provider of information relating to animal welfare the content provider might be indicated for that type of content in a publication such as a web page associated with animal welfare. Any suitable criteria may be used to determine value for a content provider. Control is passed to operation 645 and process 600 continues.

In operation 645 process information is recorded. For example, value associated with a content provider may be adjusted, or value associated with a content consumer might be debited based on content consumption. Status of a content file may be modified to indicate that content has been distributed to a content consumer, which might affect factors such as shelf life, content rating, and content metadata relating to subject matter, future expected value, production quality, etc. Information regarding content consumers and/or content providers may be adjusted based on results of the process 600. For example a rating or ranking related to a keyword, classification, tag, metadata, geographic location, etc., associated with a content provider, a content consumer and/or a content file might be adjusted. Process information may be recorded in any suitable element of the system 100 (FIG. 1). Control is passed to operation 605 and process 600 continues.

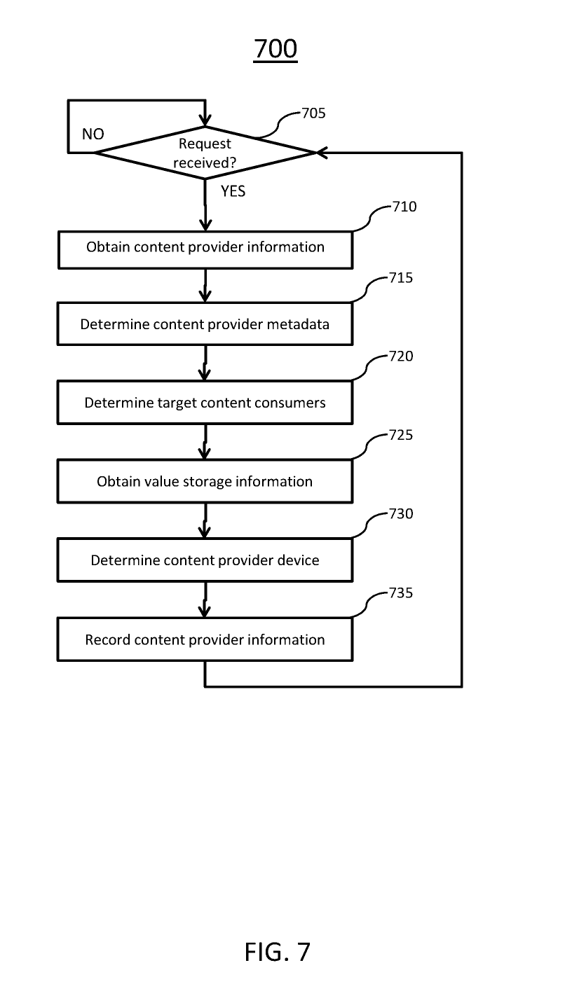

As illustrated in FIG. 7 a process 700 for registering a content provider is provided. The process 700 may be performed in whole or in part by any suitable element of the system 100(FIG. 1). In at least one embodiment, the process 700 is operative on the content distribution server 125. A request to register a content provider may originate from any device available in the system 100. A request to register a content provider may originate from a content provider system using a web form provided by the content server system 125 (FIG. 1).

In operation 705 (FIG. 7) a determination is made as to whether a request to register a content provider is received. If it is determined in operation 705 that a request to register a content provider is not received, control remains at operation 705 and process 700 continues. If it is determined in operation 705 that a request to register a content provider is received, control is passed to operation 710 and process 700 continues.

The determination in operation 705 may be made using various criteria. In at least one embodiment, if a request to register a content provider is received at a server associated with the content server system 125 (FIG. 1), it may be determined that a request to register a content provider is received. For example, if a request is received from a content provider system at an address associated with content server system 125 it may be determined that a request to register a content provider is received. An authorization and/or verification process including security data may be required as part of a determination that a request to register a content provider is received.

In operation 710 content provider information is obtained. Content provider information may include information such as PII, banking and taxation information, device information, physical address information, etc. A content provider may be required to create a user identifier and a password, or present security credentials associated with an identity provider such as Google, Facebook, Amazon, etc. Control is passed to operation 715 and process 700 continues.

In operation 715 content provider metadata is determined. Content provider metadata may be determined in various ways. For example, a profile of a content provider with a service such as LinkedIn®, Facebook®, etc., may be analyzed to determine content provider metadata. Content of content files provided by a content provider may be analyzed to determine metadata associated with a content provider. A content provider may be required to provide specified information and/or make selections which associate metadata with a content provider. Control is passed to operation 720 and process 700 continues.

In operation 720 target content consumers are determined. For example, governmental and/or public agencies which are associated with a geographic location associated with a content provider may be identified as target content consumers. Content consumers highly ranked for metadata associated with a content provider may be selected as target content consumers. A content provider may be provided with a user interface for selection of target content providers. Control is passed to operation 725 and process 700 continues.

In operation 725 value storage information is obtained. Value storage information may include financial transaction information which may be used to provide compensation to a content provider. Value storage information may include intangible forms of compensation which a content provider accepts. Value storage information may include communication information regarding an organization which is to receive value information associated with a content provider. Control is passed to operation 730 and process 700 continues.

In operation 730 a content provider device is determined. In an embodiment, at least one content provider device must be associated with a content provider. A content provider may be associated with any number of devices. For example, a content provider may provide access information of a number of devices which may generate a request to provide content. A content provider device may be verified in order to ensure that a content provider has control over the content provider device. Identification of a content provider device may be used to verify ownership rights associated with a content file provided by a content provider device. For example, a content provider might have access to a number of devices such as a security camera, a cell phone, a dashboard camera, a Point Of View (POV) device such as a body camera, a motion-activated camera, etc. Control is passed to operation 735 and process 700 continues.

In operation 735 content provider information is recorded. For example, contact information, and/or registration information, content provider devices, target content consumers, value storage information, etc., associated with a content provider may be recorded. The process 700 may be used to modify registration information which exists for a content provider. Content provider information may be recorded in any suitable element of the system 100 (FIG. 1). Control is passed to operation 705 and process 700 continues.

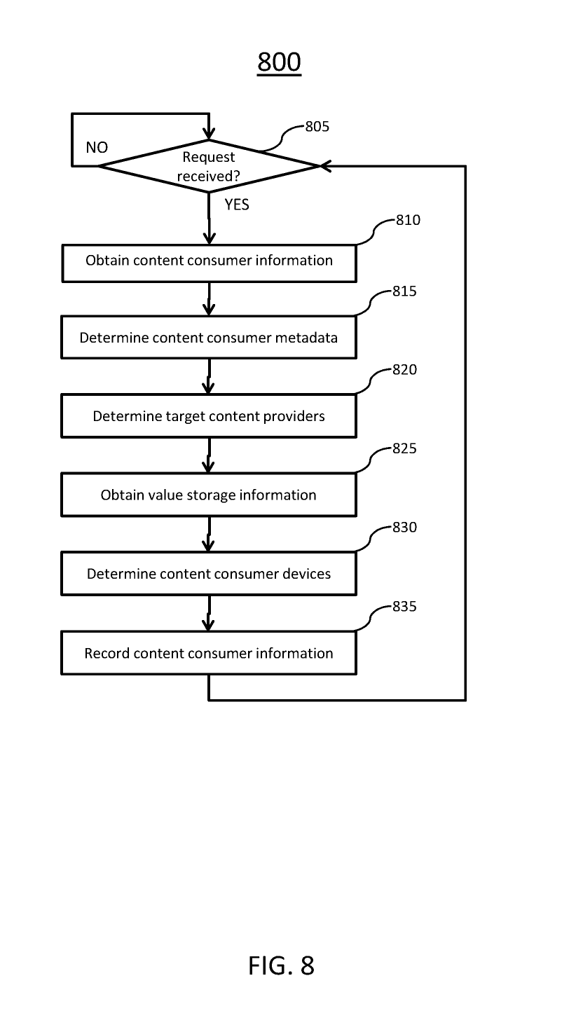

As illustrated in FIG. 8 a process 800 for registering a content consumer is provided. The process 800 may be performed in whole or in part by any suitable element of the system 100(FIG. 1). In at least one embodiment, the process 800 is operative on the content distribution server 125. A request to register a content consumer may originate from any device available in the system 100. A request to register a content consumer may originate from a content consumer system using a web form provided by the content server system 125 (FIG. 1).

In operation 805 (FIG. 8) a determination is made as to whether a request to register a content consumer is received. If it is determined in operation 805 that a request to register a content consumer is not received, control remains at operation 805 and process 800 continues. If it is determined in operation 805 that a request to register a content consumer is received, control is passed to operation 810 and process 800 continues.

The determination in operation 805 may be made using various criteria. In at least one embodiment, if a request to register a content consumer is received at a server associated with the content server system 125 (FIG. 1), it may be determined that a request to register a content consumer is received. For example, if a request is received from a content consumer system at an address associated with content server system 125 it may be determined that a request to register a content consumer is received. An authorization and/or verification process including security data may be required as part of a determination that a request to register a content consumer is received.

In operation 810 content consumer information is obtained. Content consumer information may include information such as PII, banking and taxation information, device information, physical address information, etc. A content consumer may be required to create a user identifier and a password, or present security credentials associated with an identity provider such as Google, Facebook, Amazon, etc. Control is passed to operation 815 and process 800 continues.

In operation 815 content consumer metadata is determined. Content consumer metadata may be determined in various ways. For example, a profile of a content consumer with a service such as Linkedln®, Facebook®, etc., may be analyzed to determine content provider metadata. Content of content files provided by a content consumer may be analyzed to determine metadata associated with a content consumer. A content consumer may be required to provide specified information and/or make selections which associate metadata with a content consumer. Control is passed to operation 820 and process 800 continues.

In operation 820 target content providers are determined. For example, content providers which are verified may be selected as target content providers by governmental agencies. Content providers which have obtained certification for production of various types of content may be determined to be target content providers. Content providers which are located within a pre-determined geographic area may be determined to be target content providers. Any suitable criteria may be used to determine target content providers. Control is passed to operation 825 and process 800 continues.

In operation 825 value storage information is obtained. Value storage information may include financial transaction information which may be used to obtain compensation from a content consumer. Value storage information may include intangible forms of compensation which a content consumer provides. Value storage information may include communication information regarding an organization which is to receive value information associated with a content consumer. Control is passed to operation 830 and process 800 continues.

In operation 830 a content consumer device is determined. In an embodiment, at least one content consumer device must be associated with a content consumer. A content consumer may be associated with any number of devices. For example, a content consumer may provide access information of a number of devices which may generate a request to distribute content content. A content consumer may expose an Application Programming Interface (API) which may be used to deliver information of available content to a content consumer. Control is passed to operation 835 and process 800 continues.

In operation 835 content consumer information is recorded. For example, contact information, and/or registration information, content consumer devices, target content providers, value storage information, etc., associated with a content provider may be recorded. The process 800 may be used to modify registration information which exists for a content consumer. Content consumer information may be recorded in any suitable element of the system 100 (FIG. 1). Control is passed to operation 805 and process 800 continues.

While the database and data structures utilized in implementation of the embodiments herein have been described using particular examples and configurations no limitation is implied thereby. Any technologies which may implement the features of the system which are well known in the art and may provide equivalent functionality may be used to implement the methods and system described and are within the scope of the embodiments described herein.

Using the methods and systems described herein, a method and system for distribution of video content is described. A server is provided which may allow content providers to obtain, distribute and receive compensation for content. In particular timely newsworthy content on any of a variety of subjects may be provided to a distribution service. Without requiring any knowledge on the part of the content provider of various content consumers, content can be delivered to suitable content consumers. A content provider may achieve wider distribution of content and may receive a greater portion of the value generated by content which is provided.

Content is associated with metadata which is associated with a plurality of content consumers such as news agencies, redistributors, and interested public and private entities. Content can be delivered timely to interested content consumers with reasonable licensing terms without the need for negotiation of licensing terms. A content provider may be able to distribute content via multiple channels based on content age, content related metadata, and demand from content consumers. A content provider may receive notifications of events which may provide opportunities to acquire content based on breaking news, events such as weather, and public safety scanning which may prompt a provider to obtain content and/or to provide content which would otherwise not be published.

Content can be segmented by subject matter, location, time, etc., to provide a richer experience for content consumers. Content consumers are enabled to obtain relevant timely news worthy content without the requirements of a ‘push’ system to predict future events.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The present invention may be implemented using a program stored, for example, in a computer-readable storage medium such as a CD-ROM, etc., or using one or more specialized terminals, devices or systems that is enabled to execute operation(s) described herein. The storage or recording medium used in an embodiment can be selected from among various computer-readable media including, a disk, a DVD, an internal storage device (memory such as RAM or ROM) in a computer, etc.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method for distributing video content comprising:
obtaining information which accesses video content;
associating metadata with the video content;
ranking content consumers based on the metadata;
providing information of the video content to the content consumers based on the ranking; and
delivering access to the video content based on responses obtained from the content consumers.

2. The method of claim 1 further comprising:
associating the metadata based on tags selected from a dictionary of tags associated with the content consumers.

3. The method of claim 2 further comprising:
associating the metadata based on an action of a content provider that provides the information.

4. The method of claim 1 further comprising:
associating the metadata based on analysis of the video content using image and facial recognition.

5. The method of claim 1 further comprising:
associating the metadata to determine the characteristics of the access provided.

6. The method of claim 1 further comprising:
associating the metadata to determine if a content provider is able to redistribute the content; and
immediately providing the access to the content provider based on the metadata.

7. The method of claim 1 further comprising:
associating the metadata with a content consumer based on historical information of consumption of content by the content consumer.

8. The method of claim 1 further comprising:
associating the metadata with a content provider based on historical information of consumption of content by the content consumers.

9. The method of claim 1 further comprising:
determining the metadata based on geographic location associated with the content consumers and a device used to obtain the content.

10. The method of claim 1 further comprising:
determining a value associated with the responses and providing the access based on the value.

11. The method of claim 10 further comprising:
determining the value associated with the responses based on compensation provided to a content provider for content associated with the metadata.

12. The method of claim 1 further comprising:
providing a derivative of the video content to a group of devices based on the metadata; and
calculating compensation associated with the video file based on a response received from a device associated with the group.

13. The method of claim 1 further comprising:
providing the video file to a content consumer; and
ranking the content consumer based on compensation provided for the video content.

14. A system comprising:
a server device obtaining information which accesses video content, associating metadata with the video content, ranking content consumers based on the metadata, providing information of the video content to the content consumers based on the ranking, and delivering access to the video content based on responses obtained from the content consumers;
a content provider device obtaining the information which accesses video content; and
a content consumer device receiving the video content.

15. A non-transitory computer readable storage medium storing therein a program for causing a computer to execute an operation comprising:
obtaining information which accesses video content;
associating metadata with the video content;
ranking content consumers based on the metadata;
providing information of the video content to the content consumers based on the ranking; and
delivering access to the video content based on responses obtained from the content consumers.
